(19) United States
(12) Patent Application Publication
(10) Pub. No.: US 2026/0177138 A1
(43) Pub. Date: Jun. 25, 2026

(54) GEAR RING ASSEMBLY

(71) Applicant: Schaeffler Technologies AG & Co. KG, Herzogenaurach (DE)

(72) Inventors: Trent Hendershot; Paul Cornett

(73) Assignee: Schaeffler Technologies AG & Co. KG, Herzogenaurach (DE)

(21) Appl. No.: 19/386,369

(22) Filed: Nov. 12, 2025

Related U.S. Application Data
(60) Provisional application No. 63/721,113, filed on Nov. 15, 2024.

(51) Int. Cl. F16H 55/17; F16H 55/08; F16H 57/12

(52) U.S. Cl. CPC F16H 55/17; F16H 55/08; F16H 57/12; F16H 2055/176

(57) ABSTRACT

A gear ring assembly includes a gear ring and a stamped plate. The gear ring includes an inner toothing, arranged for engaging with a mating toothing on a second gear, and an outer toothing. The stamped plate includes a cylindrical portion pressed on to the outer toothing such that the outer toothing forms a complementary toothing on an inner surface of the cylindrical portion.

### CROSS-REFERENCE TO RELATED APPLICATIONS

This application claims the benefit of U.S. Provisional Patent Application No. 63/721,113, filed Nov. 15, 2024, the disclosure of which is incorporated in its entirety by reference herein.

### TECHNICAL FIELD

The present disclosure relates generally to a gear ring, and more specifically to a gear ring assembly having a gear ring and a stamped plate.

### BACKGROUND

Electric axles are known. One example is shown and described in commonly-assigned United States Patent Publication No. 2024/0255049 titled MODULAR ELECTRIC AXLE ASSEMBLY FOR BANJO HOUSING to Angel et al., hereby incorporated by reference as if set forth fully herein.

### SUMMARY

Example aspects broadly comprise a gear ring assembly including a gear ring and a stamped plate. The gear ring includes an inner toothing arranged for engaging with a mating toothing on a second gear, and an outer toothing. The stamped plate includes a cylindrical portion pressed on to the outer toothing such that the outer toothing forms a complementary toothing on an inner surface of the cylindrical portion to rotationally connect the gear ring and the stamped plate for torque transmission without lash. In an example embodiment, the inner toothing is a helical toothing. In an example embodiment, the outer toothing is a straight toothing.

In some example embodiments, the gear ring has a smooth portion axially between circumferential rows of the outer toothing. In an example embodiment, individual teeth of each of the circumferential rows of outer toothing are aligned with one another in an axial direction. In an example embodiment, the smooth portion limits axial displacement of the stamped plate relative to the gear ring. In an example embodiment, the smooth portion is radially depressed from the outer toothing. In an example embodiment, the stamped plate also includes a radial body portion and an inner cylindrical portion, and the cylindrical portion and the inner cylindrical portion extend from the radial portion in opposite axial directions.

In some example embodiments, the stamped plate also includes an annular portion with lanced centering features arranged to position a bearing. In some example embodiments, the stamped plate also includes an inner annular portion and an inner cylindrical portion extending from the inner annular portion. In an example embodiment, the inner cylindrical portion includes an inner spline portion. In an example embodiment, the annular portion is axially offset from the inner annular portion. In some example embodiments, the gear ring includes a plurality of smooth portions arranged axially between circumferential rows of the outer toothing. In an example embodiment, the gear ring includes exactly two smooth portions and exactly three circumferential rows of outer toothing.

### BRIEF DESCRIPTION OF THE DRAWINGS

FIG. 1 illustrates a perspective view of a portion of a stamped plate.

FIG. 2 illustrates a perspective view of the portion of a stamped plate of FIG. 1 assembled with a gear ring.

FIG. 3 illustrates a perspective view of the portion of a stamped plate of FIG. 1 shown with formed teeth.

FIG. 4 illustrates a perspective view of a portion of an alternative embodiment of the gear ring of FIG. 2.

FIG. 5 illustrates a perspective view of an alternative embodiment of the portion of the stamped plate of FIG. 1 shown with formed teeth.

FIG. 6 illustrates a cross-sectional view of a gear ring assembly fixed to a mating component.

FIG. 7 illustrates a cross-sectional view of an axle assembly according to an example embodiment.

FIG. 8 illustrates a detail view of boxed area 8 in FIG. 6.

FIG. 9 illustrates a detail view of boxed area 9 in FIG. 6.

FIG. 10 illustrates a perspective view of an axle housing assembly according to an example embodiment.

FIG. 11A illustrates a cross-sectional view of a portion of the axle housing assembly of FIG. 9 shown during installation of an axle shaft.

FIG. 11B illustrates a cross-sectional view of a portion of the axle housing assembly of FIG. 9 shown during installation of an axle shaft at a time after that shown in FIG. 11A.

FIG. 12 illustrates a cross-sectional view of a portion of a stator assembly for an electric motor.

FIG. 13 illustrates a cross-sectional view of a portion of an electric motor.

FIG. 14 illustrates a cooling flow through a stator of the electric motor of FIG. 13.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

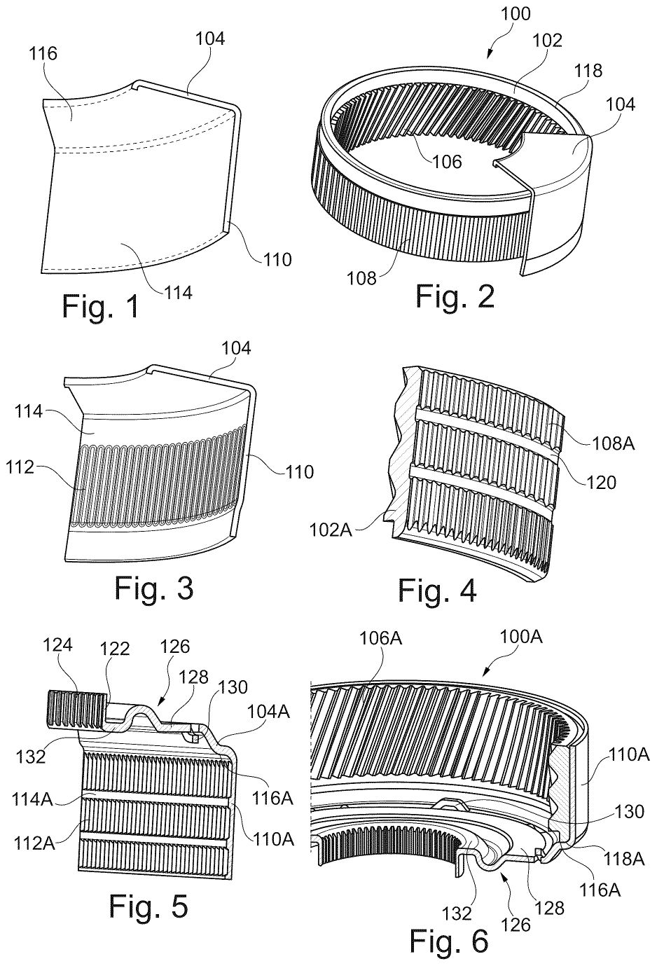

The following description is made with reference to FIGS. 1-6. FIG. 1 illustrates a perspective view of a portion of a stamped plate. FIG. 2 illustrates a perspective view of the portion of a stamped plate of FIG. 1 assembled with a gear ring. FIG. 3 illustrates a perspective view of the portion of a stamped plate of FIG. 1 shown with formed teeth. FIG. 4 illustrates a perspective view of a portion of an alternative embodiment of the gear ring of FIG. 2. FIG. 5 illustrates a perspective view of an alternative embodiment of the portion of the stamped plate of FIG. 1 shown with formed teeth. FIG. 6 illustrates a cross-sectional view of a gear ring assembly fixed to a mating component.

Gear ring assembly 100 includes gear ring 102 and stamped plate 104. Gear ring assembly 100 may be used in a gearbox for an electric axle gearbox, for example. Gear ring 102 includes inner toothing 106, arranged for engaging with a mating toothing on a second gear (not shown), and outer toothing 108. Stamped plate 104 includes cylindrical portion 110 pressed on to the outer toothing such that the outer toothing forms complementary toothing 112 on inner surface 114 of the cylindrical portion (ref. FIG. 3). For example, the stamped plate may be formed with an inside diameter greater than an outside diameter of the gear ring. After assembly with the gear ring, a sizing tool (e.g., a ring with an inside diameter less than an outside diameter of the stamped plate, not shown) is forced over the stamped plate, compressing the stamped plate such that a portion of the stamped plate is forced into toothing 108, forming toothing 112. Otherwise stated, toothing 108 acts like a forming tool creating a torque locking feature between the stamped plate and the gear ring. Toothing 108 and 112 rotationally connect the gear ring and the stamped plate for torque transmission without lash.

As shown in FIG. 2, for example, inner toothing 106 is a helical toothing and outer toothing 108 is a straight toothing. Stamped plate 104 also includes annular portion 116 extending from cylindrical portion 110 and contacting face 118 of ring gear 102. Stamped plate 104 may also include a wrapped portion extending from the cylindrical portion and contacting a face of the ring gear, opposite face 118. So, for example, after the stamped plate is secured to the gear ring, a distal end of the cylindrical portion may be rolled or formed over the gear ring to axially secure the gear ring between annular portion 116 and the wrapped portion.

Gear ring assembly 100A is similar to gear ring assembly 100 described above, except as discussed below. Reference numbers ending in “A” shown in FIGS. 4-6 correspond to the same numbers in FIGS. 1-3 without the suffix. Gear ring 102A includes smooth portion 120 axially between circumferential rows of outer toothing 108A. Therefore, when the complementary toothing is formed on the stamped plate, the smooth portion between the formed teeth limits axial displacement of the stamped plate relative to the gear ring, performing a similar function as the wrapped portion discussed above. In the embodiment shown, individual teeth of each of the circumferential rows of outer toothing are aligned with one another in an axial direction. That is, each of the circumferential rows includes a same number of outer teeth, and the rows are rotationally aligned so that the teeth are aligned when viewed axially. In the embodiment shown, the gear ring has exactly two smooth portions and exactly three circumferential rows of outer toothing.

Stamped plate 104A includes inner cylindrical portion 122 with inner spline portion 124. Inner spline portion 124 may be arranged to drivingly engage a mating spline on a shaft, for example. Cylindrical portion 110A and inner cylindrical portion 122 extend from radial body portion 126 of the stamped plate in opposite axial directions. Stamped plate 104A also includes annular portion 128 with lanced centering features 130 that may be arranged to position a bearing, for example. Cylindrical portion 122 extends from inner annular portion 132. Annular portions 116A and 132 are axially offset.

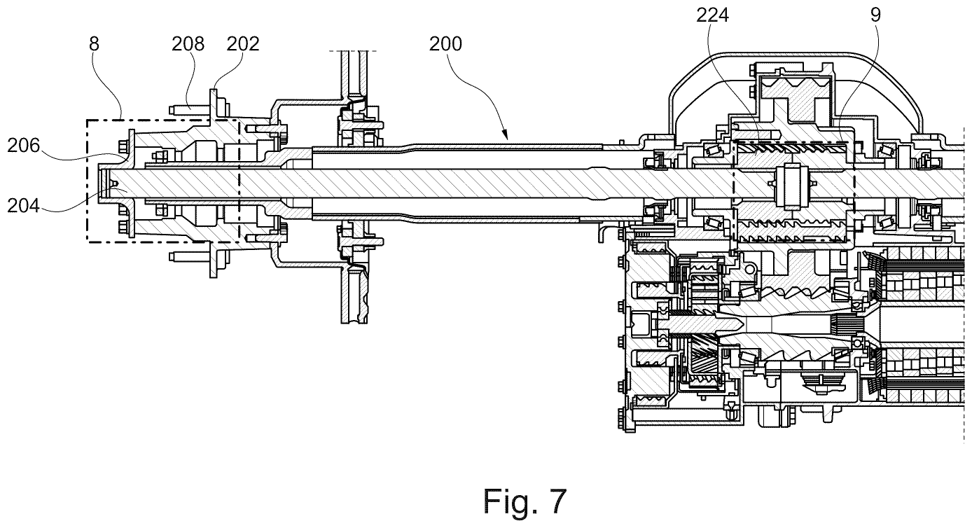

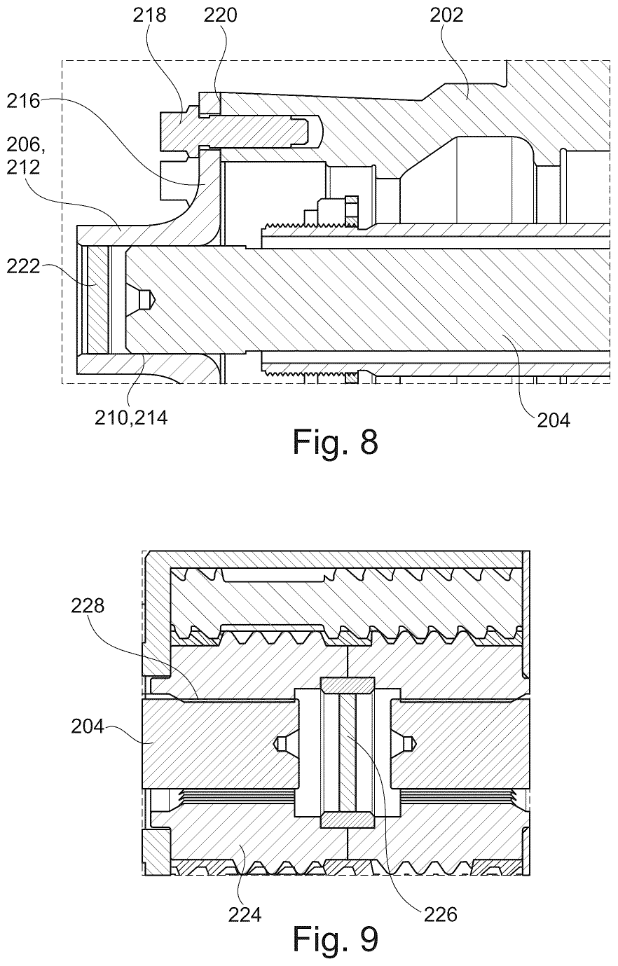

The following disclosure is made with reference to FIGS. 7-9. FIG. 7 illustrates a cross-sectional view of an axle assembly. FIG. 8 illustrates a detail view of boxed area 8 in FIG. 7. FIG. 9 illustrates a detail view of boxed area 9 in FIG. 7. Axle assembly 200 includes drive hub 202, axle shaft 204 and flange 206. The drive hub is arranged for connection to a wheel (via drive studs 208, for example). The axle shaft extends through an entirety of the drive hub and includes spline 210. The flange includes hub portion 212 with spline 214 engaged with spline 210, and flange portion 216 extending from the hub portion and fixed to the drive hub (via bolts 218, for example). Splines 210 and 214 may be engaged as a slip-fit, for example. In other words, the splines transmit torque rotationally but are free to slide axially relative to one another. Flange 206 may be formed by stamping, for example.

Flange portion 216 is sealed to the drive hub via seal 220, for example. Although an o-ring type seal is shown, other embodiments (not shown) may include a paper, cork or rubber gasket, for example. Axle assembly 200 also includes retaining plate 222 secured in the hub portion for limiting axial displacement of the axle shaft. That is, because the hub and axle shaft are engaged by a slip-fit spline the axle shaft can move axially relative to the flange. Retaining plate 222 limits axial movement of the axle shaft relative to the hub and, in combination with seal 220 discussed above, seals lubricant used to lubricate bearings (not shown) within the axle assembly.

Turning to FIG. 9, axle assembly 200 also includes drive gear 224 and retaining plate 226. The drive gear is drivingly engaged with the axle shaft via spline 228, similar to engagement of the axle shaft to the flange described above. Retaining plate 226 is secured in the drive gear for limiting axial displacement of the axle shaft, similar to retaining plate 222 discussed above. Plate 222 need not seal to gear 224, however. The retaining plates may be secured in the respective components via press-fit, shrink fit, adhesives, welding, staking, or any other known method for securing two metal components together.

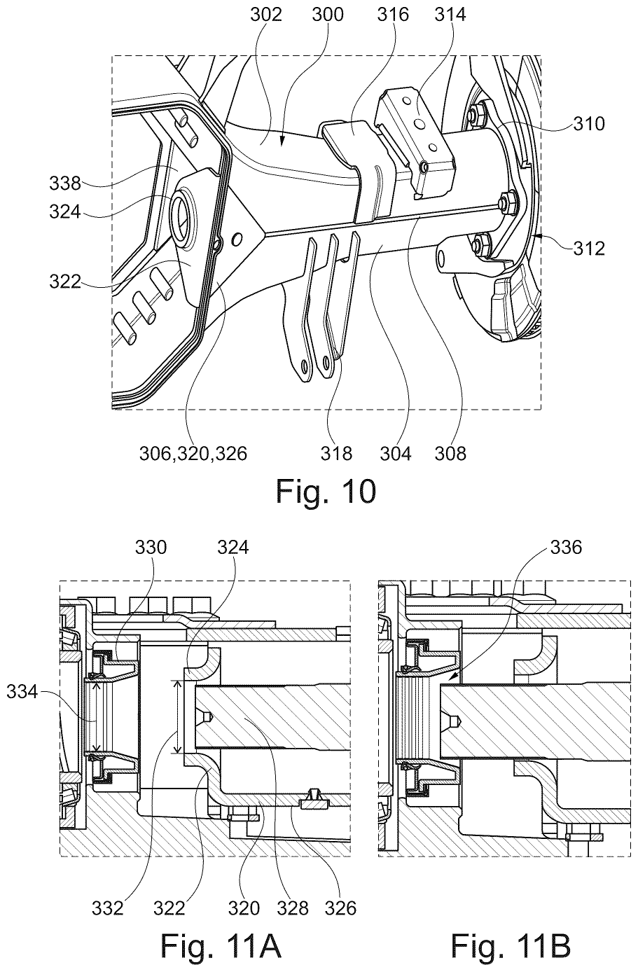

The following description is made with reference to FIGS. 10-11. FIG. 10 illustrates a perspective view of an axle housing assembly according to an example embodiment. FIG. 11A illustrates a cross-sectional view of a portion of the axle housing assembly of FIG. 10 shown during installation of an axle shaft. FIG. 11B illustrates a cross-sectional view of a portion of the axle housing assembly of FIG. 10 shown during installation of an axle shaft at a time after that shown in FIG. 11A.

Axle housing assembly 300 includes housing portions 302 and 304, and gusset 306. Housing portion 304 is fixed to housing portion 302 by weld 308, for example. Together, housing portions 302 and 304 may form a “banjo” housing, for example. Flange 310 is fixed to the housing portions and supports brake components 312, for example. Brackets 314, 316 and 318 may be arranged for fixing suspension components such as springs or shocks, for example. Gusset 306 includes plate portion 320 secured to housing portions 302 and 304, and plate portion 322 extending orthogonal to plate portion 320 and including cylindrical protrusion 324. In the embodiment shown, plate portion 320 is triangular in shape. Cylindrical protrusion 324 extends from plate portion 322 in a direction parallel to face 326 of plate portion 320. In other words, because the plate portions are orthogonal, the cylindrical protrusion extends from plate portion 322 in a direction orthogonal to plate portion 320.

Axle housing assembly 300 also includes axle shaft 328 extending through the cylindrical protrusion. Axle housing assembly 300 also includes axle seal 330 coaxial with the cylindrical protrusion. Axle seal 330 may be a unitized lip seal, for example. Cylindrical protrusion 324 includes inner diameter 332 and axle seal 330 includes inner diameter 334, less than inner diameter 332. Therefore, during assembly of the axle shaft, the cylindrical protrusion pre-aligns or pre-centers the axle shaft with the axle seal so that the seal is not damaged by the axle during installation. That is, the cylindrical protrusion will not be damaged by the axle if the axle is misaligned during installation so it can pre-align the axle shaft with the axle seal. Axle seal 330 includes conical entrance 336 arranged to correct minimal misalignment of the axle shaft after centering by the cylindrical protrusion.

Thus, the cylindrical protrusion serves as an integrated seal protector during axle installation. Integrating the cylindrical protrusion with the axle gusset saves expense by requiring fewer components and less time fixing (e.g., welding) the components together. Returning to FIG. 10, axle housing assembly 300 also includes gusset 338 aligned with and offset relative to the first gusset, and secured to the housing portions.

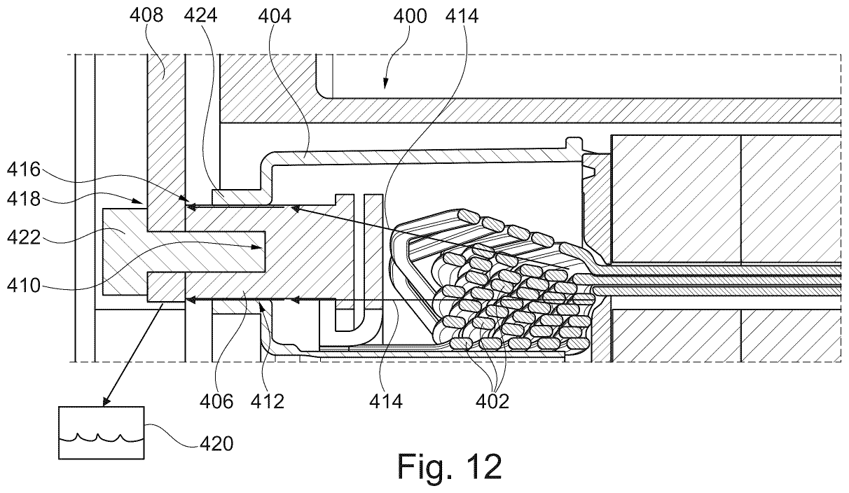

The following description is made with reference to FIG. 12. FIG. 12 illustrates a cross-sectional view of a portion of a stator assembly for an electric motor. Electric motor cooling system 400 includes wire coils 402, housing 404, phase bar 406 and busbar 408 secured to the phase bar. The housing encloses at least a portion of the wire coils. Phase bar 406 is connected to the wire coils and extends through opening 410 in the housing. Cooling system 400 is arranged to direct a cooling fluid through the plurality of wire coils and gap 412 between the opening and the phase bar to spray the busbar, as indicated by arrows 414, for example.

As shown in the figure, busbar 408 is secured to phase bar 406 at connection point 416. Cooling fluid (indicated by arrows 414) sprays the connection point. That is, cooling fluid outlet 416 of the phase bars is arranged at a location where the phases leave the enclosure and is aimed at connection point 418 to a power source (not shown) to directly cool a critical thermal connection. By moving the outlet to a point where the phase bars leave the housing, a pass-through between the phase bars and the housing need not be sealed in a conventional manner. After cooling the connection point, the cooling system is arranged such that the fluid flows to sump 420 to lubricate nearby components (not shown) and return to a cooling loop.

Connection point 416 is secured by bolt 420. Housing 404 includes necked portion 422 extending towards the busbar and the phase bar extends through the necked portion. Gap 412 is arranged between the necked portion and the phase bar. Wire coils 402 are part of an electric motor stator.

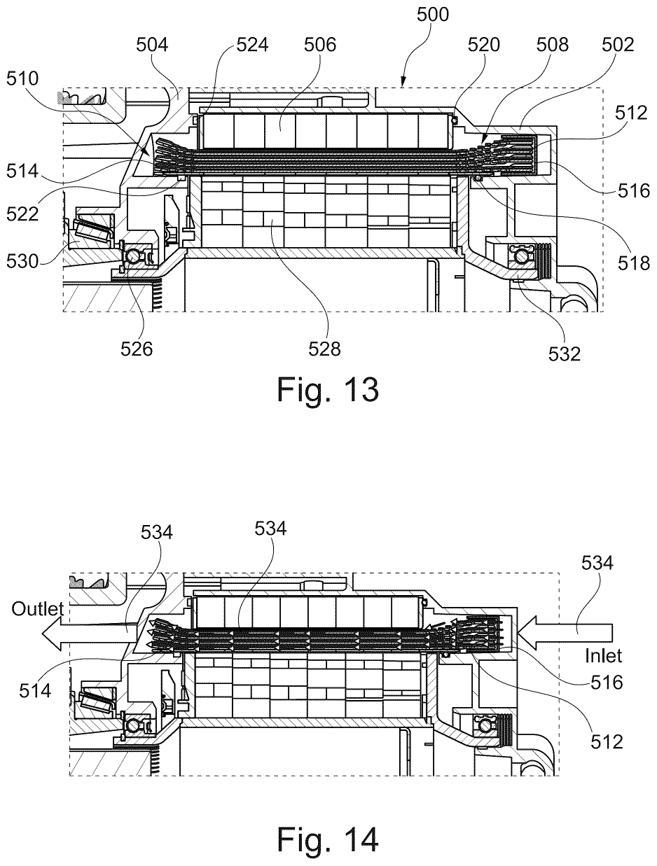

The following description is made with reference to FIGS. 13-14. FIG. 13 illustrates a cross-sectional view of a portion of an electric motor. FIG. 14 illustrates a cooling flow through a stator of the electric motor of FIG. 13. Electric motor housing assembly 500 includes housing portion 502, housing portion 504 fixed to housing portion 502, and stator 506 sealed to housing portions 502 and 504. Housing portion 502 includes integrated oil cavity 508 and housing portion 504 includes integrated oil cavity 510. Stator 506 includes wire coils 512 extending into integrated oil cavity 508, and wire coils 514 extending into integrated oil cavity 510. Housing assembly 500 also includes oil flow distributor with integrated high voltage isolators 516 surrounding wire coils 512 in integrated oil cavity 508. Stator 506 is sealed to housing portion 502 by radial seal 518 and face seal 520. Stator 506 is sealed to housing portion 504 by radial seal 522 and face seal 524.

Housing assembly 500 also includes bearing 526. Housing portion 504 forms an inner bearing wall and bearing 526 is arranged in the inner bearing wall. Bearing 526 may be a ball bearing, for example. Housing assembly 500 also includes rotor 528 rotatably mounted on bearing 526. Housing portion 504 also forms an outer bearing wall and tapered roller bearing 530 is arranged in the outer bearing wall. Housing assembly 500 also includes bearing 532 arranged in housing portion 502 and the rotor is rotatably mounted on bearing 532. Bearing 532 may be a ball bearing, for example.

As can be seen in FIG. 14, for example, integrated oil cavity 508 is an oil inlet cavity and integrated oil cavity 510 is an oil outlet cavity. That is, oil (indicated by arrows 534) is introduced in the inlet cavity, is distributed by distributor 516 to flow through wire coils 512 and 514, and exits the housing at the outlet cavity. Such a cooling arrangement provides a dedicated oil feed to the stator for proper function. This is sometimes referred to as DISCO (Direct Injected Slot Cooling with Oil) cooling. Housing portions 502 and 504 may be metal (e.g., aluminum) castings for example. This configuration eliminates bulky plastic oil cavities normally fixed and sealed to the housings, making the assembly more power dense.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100, 100A Gear ring assembly
102, 102A Gear ring
104, 104A Stamped plate
106, 106A Inner toothing (gear ring)
108, 108A Outer toothing (gear ring)
110, 110A Cylindrical portion (stamped plate)
112, 112A Complementary toothing (stamped plate)
114, 114A Inner surface (cylindrical portion 110, 110A)
116, 116A Annular portion (stamped plate)
118, 118A Face (first, ring gear)
120 Smooth portion (gear ring)
122 Inner cylindrical portion (stamped plate)
124 Inner spline portion (stamped plate)
200 Axle assembly
202 Drive hub
204 Axle shaft
206 Flange
208 Drive studs
210 Spline (first, axle shaft)
212 Hub portion (flange)
214 Spline (second, hub portion)
216 Flange portion (flange)
218 Bolts (flange portion to drive hub)
220 Seal
222 Retaining plate (first, flange)
224 Drive gear
226 Retaining plate (second, drive gear)
228 Spline (third, axle shaft to drive gear)
300 Axle housing assembly
302 Housing portion (first)
304 Housing portion (second)
306 Gusset (first)
308 Weld (housing portions)
310 Flange
312 Brake components
314 Bracket
316 Bracket
318 Bracket
320 Plate portion (first)
322 Plate portion (second)
324 Cylindrical protrusion (second plate portion)
326 Face (first plate portion)
328 Axle shaft
330 Axle seal
332 Inner diameter (first, cylindrical protrusion)
334 Inner diameter (second, axle seal)
336 Conical entrance (seal)
338 Gusset (second)
400 Electric motor cooling system
402 Wire coils
404 Housing
406 Phase bar
408 Busbar
410 Opening (housing)
412 Gap (opening and phase bar)
414 Arrows (cooling fluid)
416 Cooling fluid outlet
418 Connection point
420 Sump
422 Bolt (connection point)
424 Necked portion (housing)
500 Electric motor housing assembly
502 Housing portion (first)
504 Housing portion (second)
506 Stator
508 Integrated oil cavity (first housing portion)
510 Integrated oil cavity (second housing portion)
512 Wire coils (first plurality)
514 Wire coils (second plurality)
516 Oil flow distributor with integrated high voltage isolator
518 Radial seal (first)
520 Face seal (first)
522 Radial seal (second)
524 Face seal (second)
526 Bearing (first)
528 Rotor
530 Tapered roller bearing
532 Bearing (second)
534 Arrows (indicates oil flow)

What is claimed is:

1. A gear ring assembly, comprising:
a gear ring comprising:
an inner toothing arranged for engaging with a mating toothing on a second gear; and
an outer toothing; and
a stamped plate comprising a cylindrical portion pressed on to the outer toothing such that the outer toothing forms a complementary toothing on an inner surface of the cylindrical portion to rotationally connect the gear ring and the stamped plate for torque transmission without lash.

2. The gear ring assembly of claim 1, wherein the inner toothing is a helical toothing.

3. The gear ring assembly of claim 1, wherein the outer toothing is a straight toothing.

4. The gear ring assembly of claim 1, wherein the gear ring comprises a smooth portion axially between circumferential rows of the outer toothing.

5. The gear ring assembly of claim 4, wherein individual teeth of each of the circumferential rows of outer toothing are aligned with one another in an axial direction.

6. The gear ring assembly of claim 4, wherein the smooth portion limits axial displacement of the stamped plate relative to the gear ring.

7. The gear ring assembly of claim 4, wherein the smooth portion is radially depressed from the outer toothing.

8. The gear ring assembly of claim 1, wherein the stamped plate further comprises:
a radial body portion; and
an inner cylindrical portion, wherein the cylindrical portion and the inner cylindrical portion extend from the radial portion in opposite axial directions.

9. The gear ring assembly of claim 1, wherein the stamped plate further comprises an annular portion with lanced centering features arranged to position a bearing.

10. The gear ring assembly of claim 9, wherein the stamped plate further comprises:
an inner annular portion; and
an inner cylindrical portion extending from the inner annular portion.

11. The gear ring assembly of claim 10, wherein the inner cylindrical portion comprises an inner spline portion.

12. The gear ring assembly of claim 10, wherein the annular is axially offset from the inner annular portion.

13. The gear ring assembly of claim 1, wherein the gear ring comprises a plurality of smooth portions arranged axially between circumferential rows of the outer toothing.

14. The gear ring assembly of claim 13, wherein the gear ring comprises exactly two smooth portions and exactly three circumferential rows of outer toothing.
